(19) United States
(12) Patent Application Publication
(10) Pub. No.: US 2010/0132520 A1
(43) Pub. Date: Jun. 3, 2010

(54) METHOD AND APPARATUS FOR SLOTTING TUBULAR STEEL

(75) Inventors: Maurice William Slack, Edmonton (CA); Leon K. Jantzen, Calgary (CA)

Correspondence Address: DONALD V. TOMKINS;C/O TOMKINS LAW OFFICE, 740, 10150 - 100 STREET, EDMONTON, AB, T5J 0P6, CA

(73) Assignee: NOETIC TECHNOLOGIES INC.

(21) Appl. No.: 12/530,843

(22) PCT Filed: Mar. 28, 2008
(86) PCT No.: PCT/CA08/00601

§ 371 Date: Sep. 11, 2009

Related U.S. Application Data
(60) Provisional application No. 60/908,558, filed on Mar. 28, 2007.

(51) Int. Cl. B26D 7/08; B23D 61/02; B26D 3/00

(52) U.S. Cl. 83/14; 83/835; 83/54

(57) ABSTRACT

In a method for slotting a pipe, a sacrificial liner is inserted into the pipe and radially expanded into contact against the inner pipe wall surface, where-upon rotating blades are plunged through the pipe wall and partially into the sacrificial liner. The sacrificial liner prevents the formation of wickers, and prevents cuttings and cutting fluid from entering the interior of the pipe, thus facilitating production of wicker-free slotted pipe requiring reduced post-slotting cleaning. An apparatus for implementing the method incorporates a fixed seal sub-assembly and a movable seal sub-assembly, interconnectable to form an elongate assembly which is adjustable to suit different pipe lengths. A cylindrical re-usable liner is disposable around the assembled fixed and movable seal sub-assemblies, and sized for insertion into the sacrificial liner. The re-usable liner may be expanded by internal pressure, thereby expanding the sacrificial liner. Preferably, the slotting method uses slotting blades with curvilinear teeth thinner than the main blade body, to produce cuttings that are narrower than the finished slot width, and therefore easier to remove from the slots during slotting operations.

### FIELD OF THE INVENTION

The present invention relates in general to methods and apparatus for slotting ductile metal workpieces, including tubular steel workpieces to create slotted liners as typically used in heavy oil production from unconsolidated sand reservoirs. The invention relates in particular to methods and apparatus for slotting tubular steel whereby the formation of wickers during the slotting process may be substantially reduced or eliminated.

### BACKGROUND OF THE INVENTION

Slotted steel pipe liners are commonly used for sand control in the oil and gas industry. Typically, slotted liners are formed by cutting multiple slots in the range of 2 to 4 inches long through the pipe wall, and parallel to the axis of the liner. The purpose of the slots is to provide a flow path for fluids (e.g., steam) to be injected into a subsurface formation, or for produced fluids (e.g., oil and natural gas) to flow from a subsurface formation into a well, while preventing the ingress of particulate matter from the formation into the well bore. The slots in the liners are necessarily quite narrow, typically in the range of 0.008 to 0.030 inches wide.

Slotted liners are typically made by plunging thin, rotating circular blades radially through the liner wall to a predetermined depth, producing slots having a width substantially equal to the width of the blades used to create them. Because the blades are circular, the resultant slots are slightly longer on the outside surface of the pipe than on the inside surface of the pipe. The state of the art is such that blades thin enough to form sufficiently narrow slots, as required for slotting liners, are generally available only as single-material, typically high-speed steel (HSS) cutting tools with teeth of uniform thickness corresponding to the thickness of main body of the blades. These blades may have a variety of different tooth profiles, diameters, and surface treatments.

The relevant prior art deals predominantly with slotting tools that use indexable-style inserts to create the cutting-tool/work-piece interface. The requisite narrowness of the slots in slotted well liners precludes the use of slotting tools that use indexable-style inserts; however, a review of the prior art will be beneficial in appreciating the distinctions and benefits of the present invention.

From a machining standpoint, one difficulty in slotting operations arises in the control of the chip geometry and chip-clearing ability of the slotting tool (the phrase “chip geometry” being used herein with reference to the configuration of metal fragments formed during slotting operations). Control of chip geometry is addressed in U.S. Pat. No. 7,118,311 (Aström). Aström details slotting tool insert geometry that will divide the removed material into a plurality of chips, with the width of each chip being less than the width of the cut slot, thereby facilitating clearing of the chips from the slot. However, no prior art has been identified which addresses chip clearing in the context of cutting very narrow slots as typically required for slotted well liners.

The process of plunging a narrow blade through the wall of a tubular workpiece typically results in the formation of a thin elongate band of material (commonly referred to as a “wicker”) extending beneath the plunged blade, with one end remaining attached to the parent material. The mechanics and parameters of the cutting process (e.g., plunge rates, blade geometry) determine the geometry of the wicker, and in some cases the wicker can break off The wickers must be removed from the slotted liner in order for the liner to function with optimal effectiveness. The state of the art is that the wickers are typically removed in a separate process, subsequent to the slotting operation, and there are several known processes directed to this task.

U.S. Pat. No. 4,251,175 (Hara et al.) describes the process of inserting a stinger into the pipe that is equipped with a physical burr-removal device. However, this type of device does not effectively remove all the wickers; instead, some wickers are bent into the slots from which they originated. This acts to plug the slots, thus reducing the open area and reducing the effectiveness of the slotted liner. Canadian Patent Application No. 2,522,723 (Claerhout) illustrates a thermal de-burring process which vaporizes wickers in a slotted liner using high-temperature flame. This process can be less than optimally effective if the wickers are too large; in such cases, the heat transfer rate from the wicker to the pipe can be sufficiently large that the wickers cannot be brought to vaporization temperature without adversely affecting the properties of the base material. The vaporizing process requires the slotted liner to be washed and cleaned of cutting fluids and other hydrocarbons as a preparatory step. This washing process flattens and bends wickers, further reducing the effectiveness of the vaporization process. Both of the processes described above (Hara and Claerhout) involve extra process steps and are time and energy intensive.

During the slotting process, cutting fluid is used to lubricate the blades. This cutting fluid flows through the completed slots, collects in the inside diameter of the pipe, and subsequently gets removed from the cutting machine when the slotting operation is complete. This results in a significant amount of cutting fluid leaving the slotting machine from the machine's cutting fluid circulation system. The cutting fluid can become contaminated once outside the slotting machine, in which case it must be replaced, or else captured during the washing process and treated for re-use. Both of these options are expensive, and the treatment option risks reducing fluid quality.

Known slotting processes typically generate large volumes of cuttings. The bulk of these cuttings are dragged out of the slotting machines with the oil-wet pipe, as well as on the inside diameter of the pipe. These chips are very fine and cause wear in the pipe-handling equipment, and they present a safety hazard to personnel. It is difficult and expensive to handle these chips outside of the slotting machines.

For the foregoing reasons, there is a need for improved methods and apparatus for cutting slots in tubular steel. In particular, there is a need for methods and apparatus that will allow narrow slots to be cut into steel pipe, such as for purposes of slotted well liners, without allowing cuttings to accumulate inside the slotted pipe, and without leaving wickers on the inner pipe walls. The present invention is directed to these needs.

### BRIEF SUMMARY OF THE INVENTION

The present invention provides methods and apparatus for achieving improved slotting blade geometry and improved slotting efficiency for purposes of forming slotted tubular steel liners, while at the same time allowing through-wall slots to be cut without producing “wickers” on the inside of the tubular where the slotting blade emerges through the wall of the tubular.

Accordingly, in a first aspect the present invention is a circular blade for cutting thin slots in tubular steel. As used in this patent specification, the term “thin slot” refers to slots having a width less than or equal to approximately 0.0625 inches). The blade is configured such that all chips produced during slotting operations will be narrower than the slot width. As a result of the novel geometry of the blade, clearance of chips from cut slots is facilitated, and loads acting on the blade during slotting operations are reduced, thus reducing blade wear and blade breakage as well as related repair and maintenance costs.

In a second aspect, the present invention is a method for cutting slots in tubular steel, comprising the steps of inserting an inflatable sacrificial liner into a section (or “joint”) of pipe to be slotted, pre-loading the sacrificial liner into substantially uniform contact against the inside surface of the pipe, and plunging one or more rotating circular slotting blades through the wall of the pipe and partially into the sacrificial liner. As the blades emerge through the inner face of the pipe wall, the liner prevents or deters the formation of wickers, and prevents cuttings and cutting fluid from entering the inside diameter of the pipe. The next step in the process is to remove the liner from the pipe, leaving a substantially wicker-free bore. In preferred embodiments of the method of the invention, the blades used in the slotting operation are configured in accordance with the aforesaid first aspect of the invention. Additional but non-essential steps in the method of the invention may include flushing the pipe (after slotting) with cutting fluid, wiping the slotted pipe as it leaves the slotting machine to keep the cuttings and the cutting fluid in the slotting machine where they can be handled efficiently, and washing the pipe to remove cutting fluid.

In a third aspect, the present invention is an apparatus for slotting tubular steel in accordance with the method of the invention, as generally described above. In the preferred embodiment, the apparatus comprises an elongate seal assembly incorporating a sealable, expandable, and essentially permanent or re-usable cylindrical liner. In use, the seal assembly is inserted into a sacrificial liner (which may be replaced once its useful life is over), whereupon the complete seal assembly, with the sacrificial liner in place, is inserted into a joint of pipe to be slotted. A pressurizing fluid is then introduced into the re-usable liner so as to exert radially outward pressure against the sacrificial liner and urge it into close contact with the inner cylindrical surface of the pipe. The pipe may then be slotted using a conventional slotting machine, adjusted such that the slotting blades do not extend inward from the inner surface of the pipe by a distance greater than the thickness of the sacrificial liner. The sacrificial liner, being pressed radially outward against the inner surface of the pipe, prevents the formation of wickers extending into the pipe, and thus facilitates removal of metal chips and cuttings from cut slots, due to the action of the rotating slotting blade. The re-usable liner and seal assembly allow the pressurizing fluid to be contained when replacing the sacrificial liner.

Using the method of the present invention, the process of slotting pipe is simplified because the wicker-removal and internal cleaning steps of conventional slotting processes are largely or completely eliminated. The efficiency of slotting operations is improved because:
blade breakage is reduced, thus reducing down-time for blade replacement;
the process results in a better finished product with slots that are substantially free of wickers or other debris from the slotting process, which would otherwise clog the slots and impede fluid flow through the slots;
the need for a secondary wicker removal or cleaning process is reduced or eliminated
cutting fluid waste is reduced;
the need for cuttings handling equipment outside the slotting machine is reduced, and
the necessary extent and duration of post-slotting washing operations are reduced.

### BRIEF DESCRIPTION OF THE DRAWINGS

Exemplary and non-limiting embodiments of the invention will now be described with reference to the accompanying figures, in which numerical references denote like parts, and in which:

FIG. 1 is a side view of embodiment of a circular slotting blade in accordance with the present invention.

FIG. 2 is an isometric view of an embodiment of the liner seal assembly of the present invention, shown without the re-usable liner installed.

FIG. 3 is a longitudinal cross-section through the fixed seal sub-assembly of the liner seal assembly shown in FIG. 2.

FIG. 4 is a longitudinal cross-section through the movable fixed seal sub-assembly of the liner seal assembly shown in FIG. 2.

FIG. 5 is a longitudinal cross-section through the seal assembly with the re-usable liner installed.

FIG. 6 is a longitudinal cross-section showing the seal assembly disposed within a sacrificial liner, and with the re-usable liner expanded.

FIG. 7 is a longitudinal cross-section showing the seal assembly and sacrificial liner disposed within a length of pipe, with the re-usable liner expanded.

FIG. 8 is an isometric cross-section through the seal assembly and pipe shown in FIG. 7.

### DESCRIPTION OF THE PREFERRED EMBODIMENTS

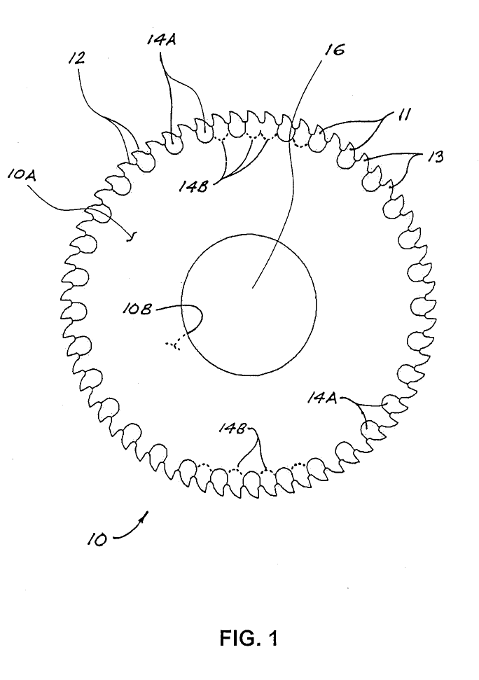

FIG. 1 illustrates an embodiment of a circular blade 10 in accordance with a first aspect of the present invention, particularly adapted for uses such as slotting tubular steel. Blade 10 has a central arbor opening 16, for mounting blade 10 on the rotatable arbor of a slotting machine, plus a plurality of generally curvilinear teeth 12 arrayed around the circumference of blade 10. Blade 10 has a first face 10A (shown in FIG. 1) and an opposite second face 10B. The thickness of teeth 12 is less than the thickness of blade 10, such that each tooth 12 has both an inner face 11 and an outer face 13, with each outer tooth face 13 being flush with either first face 10A or second face 10B of blade 10, and with outer tooth faces 13 being alternatingly flush with first face 10A and second face 10B from one tooth 12 to the next. This feature has the effect of reducing the width or thickness of metal chips or cuttings that teeth 12 cut from tubular steel workpieces (or other metal workpieces).

In preferred embodiments, a thinned or recessed area 14 is formed into one face of blade 10 in association with and radially inwardly adjacent to each tooth 12, such that each recessed area 14 is flush with inner face 11 of the corresponding tooth 12. It follows that recessed areas 14 alternate from first face 10A and second face 10B of blade 10 from one recessed area 14 to the next. By virtue of recessed areas 14A and 14B alternating from one side of blade 10 to the other, the width of the slots cut by blade 10 will be equal to the full basic thickness of blade 10, thereby allowing blade 10 to be plunged fully through the tubular wall. In addition, the staggering of recessed areas 14A and 14B has the beneficial effect of optimally distributing cutting wear over the maximum number of teeth.

Recessed areas 14 provide additional space to facilitate removal or ejection of blade chips or cuttings during slotting operations. In the embodiment shown in FIG. 1, each recessed area 14 has a generally curvilinear shape. The particular curvilinear shape of recessed areas 14A and 14B in the preferred embodiment shown in FIG. 1 is not essential to the slotting blade of the present invention. Other geometric configurations of recessed areas 14A and 14B may be devised without departing from the present concepts.

The thickness of teeth 12 (and their associated recessed areas 14A and 14B) preferably will not be less than one-half the basic thickness of blade 10.

In the illustrated embodiment, blade 10 has a total of 65 teeth 12, but blade 10 is not limited by this or any other particular number of teeth 12. For blades with an odd number of teeth 12, it is preferable to form a pair of recessed areas (14A or 14B, as the case may be) on a selected face (10A or 10B) of blade 10 in association with a pair of adjacent teeth 12, as shown by way of example in FIG. 1 in the upper region of blade 10. This ensures that each tooth 12 has an associated recessed area (14A or 14B) while also ensuring that no tooth 12 has a recessed area (14A or 14B) on both sides (which would result in excessively reduced tooth and blade thicknesses in localized areas).

The illustrated embodiment of the first aspect of the present invention will be most advantageous when the aspect ratio between the final slot depth and the thickness of the blade is substantially large (i.e., greater than approximately 10). In large aspect ratio slotting, chips of material removed from the workpiece by the slotting blade must travel larger distances relative to the width of the slot in order to clear the slot, thus increasing the chances of jamming or galling. Such large aspect ratios are commonly present in cases where slots of typical width (0.008 to 0.030 inches) are created in liner materials of typical thicknesses (0.250 to 0.500 inches).

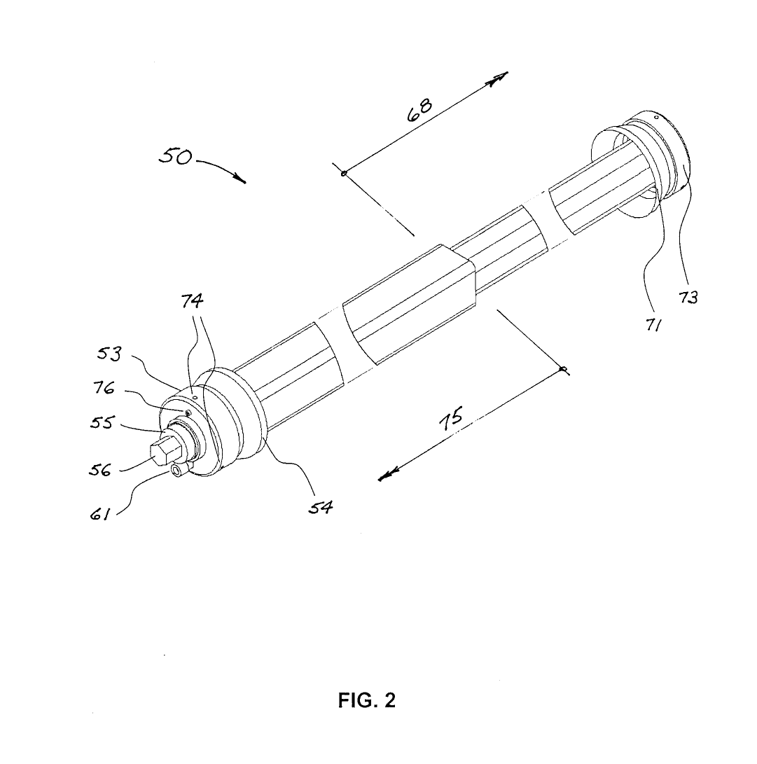

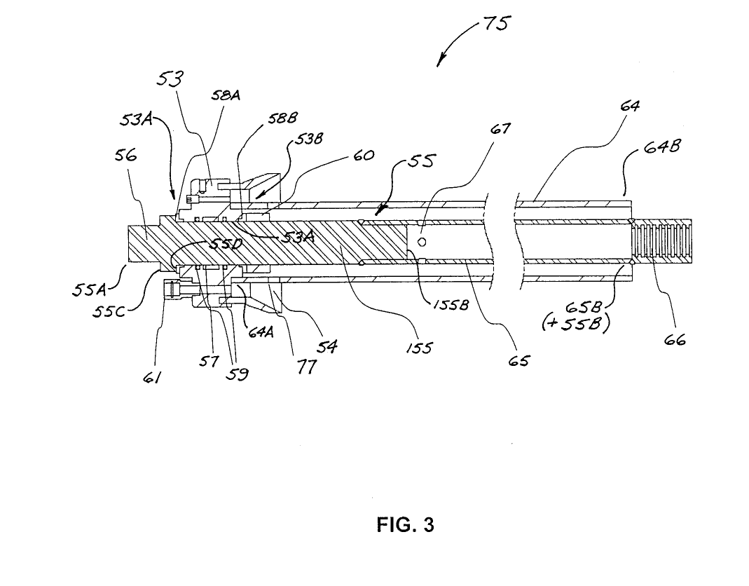

FIGS. 2 through 7 illustrate a preferred embodiment of a liner assembly 50 for implementing the method of the invention. FIG. 2 illustrates the basic structure of liner assembly 50 in isometric view, before installation of the re-usable and sacrificial liners (described later herein). Liner assembly 50 comprises an elongate fixed seal sub-assembly 75 and an elongate movable seal-sub-assembly 68. As shown in detail in FIG. 3, fixed seal sub-assembly 75 comprises a fixed seal body 53 adapted to receive a primary cup seal 54, for containing a pressurizing fluid (as described later herein). Fixed seal sub-assembly 75 further comprises a round nut-drive shaft 55 mounted co-axially to fixed seal body 53, through a corresponding bore 53A therein.

Nut-drive shaft 55 has an outer end 55A and an inner end 55B. Outer end 55A of nut-drive shaft 55 incorporates a drive head 56, for engagement by a preferably motorized wrench (not shown) in order to rotate nut-drive shaft 55. Nut-drive shaft 55 also has an annular ring 55C inwardly adjacent to drive head 56, with an annular shoulder 55D on the inward face of annular ring 55C, an indicated in FIG. 3. Nut-drive shaft 55 is held in place axially by an outer thrust bearing 58A and an inner thrust bearing 58B, which are disposed at axially opposite ends of fixed seal body 53, with shoulder 55D of nut-drive shaft 55 bearing against outer thrust bearing 58A and with inner thrust bearing 58B being retained by a shaft retainer nut 60. Nut-drive shaft 55 is rotatable relative to fixed seal body 53, and is maintained in coaxial position relative thereto by means of an axial bearing 57. Nut-drive shaft 55 is sealed relative to fixed seal body 53 by shaft seals 59 to prevent the escape of pressurizing fluid (as will be described).

Inner end 55B of nut-drive shaft 55 is provided with a screw nut 66 for engagement with an elongate screw shaft 70 forming part of movable seal sub-assembly 68 (as will be described herein). In order for screw nut 66 to be fully engageable with screw shaft 70, it is necessary for a substantial innermost portion of nut-drive shaft 55 to be hollow, for receiving the portion of screw shaft 70 extending through screw nut 66. In alternative embodiments, this requirement could be achieved by providing nut-drive shaft 55 in substantially unitary form, fashioned from round pipe stock or, alternatively, from solid bar stock bored out as appropriate to receive screw shaft 70. In the preferred and illustrated embodiments, however, nut-drive shaft 55 has two sub-components, namely: an outer shaft section 155 incorporating screw nut 66 and annular ring 55C as previously described, and having an inner end 155B); and an elongate hollow extension shaft 65 having a first end 65A and a second end 65B. Inner end 155B of outer shaft section 155 is connected to first end 65A of extension shaft 65 (such as by welding), and screw nut 66 is connected to second end 65B of extension shaft 65, such that outer shaft section 155, extension shaft 65, and screw nut 66 are in coaxial alignment.

As shown in FIG. 3, fixed seal sub-assembly 75 also includes an anti-rotation outer tube 64 having an outer end 64A and an inner end 64B. In preferred embodiments, anti-rotation outer tube 64 is a length of hollow square tubing. Anti-rotation outer tube 64 is disposed coaxially around nut-drive shaft 55, with outer end 64A of anti-rotation outer tube 64 being connected to fixed seal body 53, and with inner end 64B of anti-rotation outer tube 64 extending to the vicinity of screw nut 66 at inner end 55B of nut-drive shaft 55. In the preferred embodiment shown in the Figures, anti-rotation outer tube 64 extends only to the juncture between screw nut 66 and inner end 55B of nut-drive shaft 55 (which in the illustrated embodiment also corresponds to inner end 65B of extension shaft 65). However, this particular configuration is not essential to the invention. In variant embodiments, inner end 64B of anti-rotation outer tube 64 may extend to a point either short of or beyond screw nut 66, as may be desired to suit specific applications.

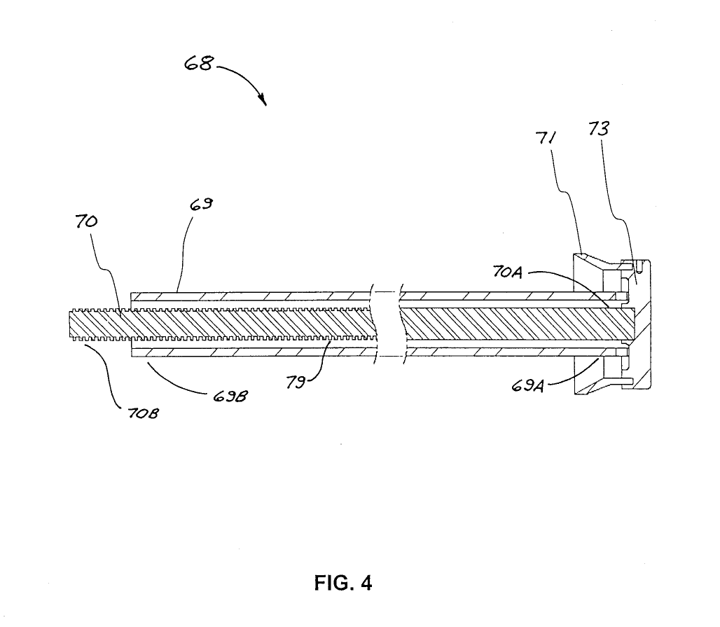

As illustrated in FIG. 4, movable seal sub-assembly 68 comprises a movable seal body 73 which retainingly receives a secondary cup seal 71. Screw shaft 70 has an outer end 70A which is securely connected to movable seal body 73, and a free inner end 70B. At least an innermost portion of screw shaft 70 is formed with a screw thread 79, for engagement with screw nut 66 of fixed seal sub-assembly 75. As may be seen from the Figures, it is not strictly necessary for the entire length of screw shaft 70 to be threaded; as shown in FIG. 4, an outer portion of screw shaft 70 may be unthreaded depending on the desired operational capabilities of a given embodiment of liner assembly 50.

As shown in FIG. 4, movable seal-sub-assembly 68 also includes an anti-rotation inner tube 69 having an outer end 69A and an inner end 69B. In preferred embodiments, anti-rotation inner tube 69 is a length of hollow square tubing. Anti-rotation inner tube 69 is disposed coaxially around screw shaft 70, with outer end 69A of anti-rotation inner tube 69 being connected to movable seal body 73, and with inner end 69B of anti-rotation inner tube 64 extending to the vicinity of inner end 70B of screw shaft 70. In the preferred embodiment shown in the Figures, anti-rotation inner tube 69 extends to a point short of inner end 70B of screw shaft 70. However, this particular configuration is not essential to the invention. In variant embodiments, anti-rotation inner tube 69 may extend to a point coincident with or beyond inner end 70B of screw shaft 70, depending on the relative configuration of anti-rotation outer tube 64 and screw nut 66 of fixed seal sub-assembly 75, and the desired operational capabilities of a given embodiment of liner assembly 50.

The outer shape and dimensions of anti-rotation inner tube 69 will be slightly smaller than those of anti-rotation outer tube 64, such that anti-rotation inner tube 69 can be slidably disposed within anti-rotation outer tube 64, and such that when anti-rotation inner tube 69 is so disposed within anti-rotation outer tube 64, relative rotation between anti-rotation outer tube 64 and anti-rotation inner tube 69 is prevented. As previously mentioned, anti-rotation outer tube 64 and anti-rotation inner tube 69 are lengths of square tubing in the preferred embodiments of the invention. However, tubular members of other shapes could be used for anti-rotation outer tube 64 and anti-rotation inner tube 69 without departing from the scope of the present invention. To provide only a few non-limiting examples, anti-rotation outer tube 64 and anti-rotation inner tube 69 could be fabricated from hexagonal or octagonal shapes. Alternatively, anti-rotation outer tube 64 and anti-rotation inner tube 69 could be fashioned from round pipe formed or fitted with a key-and-slot or other arrangement in accordance with well-known machinery principles which would permit anti-rotation outer tube 64 and anti-rotation inner tube 69 to move longitudinally relative to each other while at the same time preventing relative rotation.

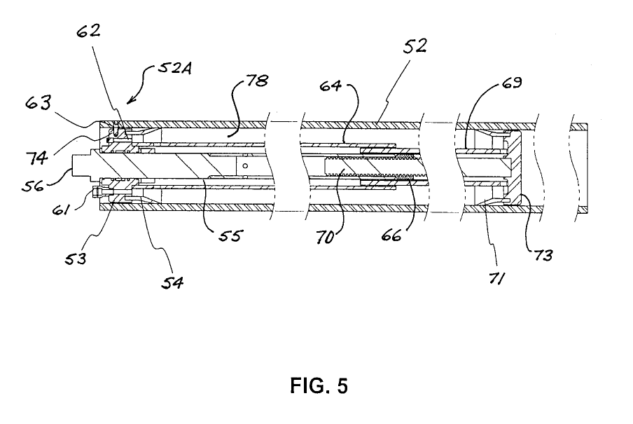

FIG. 5 shows fixed seal sub-assembly 75 assembled with movable seal sub-assembly 68, with screw shaft 70 of movable seal sub-assembly 68 threadingly engaging screw nut 66 of fixed seal assembly 75, and with anti-rotation inner tube 69 of movable seal sub-assembly 68 slidingly disposed within anti-rotation outer tube 64 of fixed seal assembly 75. Rotation of nut-drive shaft 55 of fixed seal assembly 75 (by means of drive head 56) turns screw nut 66 over screw shaft 70, thereby moving movable seal member 73 either toward or away from fixed seal member 53, depending on the direction of rotation of extending or retracting the movable seal assembly 68. During this procedure, nut-drive shaft 55 rotates within and relative to anti-rotation outer tube 64, which in turn prevents rotation of anti-rotation inner tube 69 and movable seal body 73. In this way, the overall length of the assembled fixed seal sub-assembly 75 and movable seal sub-assembly 68 can be adjusted to accommodate different lengths of pipe to be slotted in accordance with the method of the present invention, and the lengths of screw shaft 70 and nut-drive shaft 55 will preferably be selected to accommodate an expected range of pipe lengths.

In the illustrated embodiments of seal assembly 50, fixed seal assembly 75 incorporates nut-drive shaft 55 with screw nut 66, with nut-drive shaft being rotatable (by means of drive head 56) such that screw nut 66 threadingly engages non-rotating screw shaft 70 of movable seal sub-assembly 68. However, this specific arrangement is not essential to the invention. Persons of ordinary skill in the art will appreciate that this mechanism can be readily modified without affecting basic operational effectiveness and without departing from the scope of the invention. For example, nut-drive shaft 55 and screw shaft 70 could be interchanged, with a rotatable variant of screw shaft 70 being rotatably incorporated into fixed seal assembly 75 in place of nut-drive shaft 55 (and operable by drive head 56), and with a non-rotating variant of nut-drive shaft 55 being incorporated into movable seal sub-assembly 68 in place of screw shaft 70.

The fully-assembled liner assembly 50 of the invention also comprises a re-usable liner 52 of generally cylindrical configuration, and sized to receive the assembled fixed seal sub-assembly 75 and movable seal sub-assembly 68 as shown in FIG. 5. Re-usable liner 52 has a connection end 52A adapted for being securely connected to fixed seal body 53. In the illustrated embodiment, this connection is made by means of anchor screws 63 which pass through the wall of re-usable liner 52 and enter mating anchor screw holes 74 in fixed seal body 53. Re-usable liner 52 is sized such that when it is disposed around the assembled fixed seal sub-assembly 75 and movable seal sub-assembly 68 as shown, primary cup seal 54 (of fixed seal sub-assembly 75) and secondary cup seal 71 (of movable seal sub-assembly 68) will come into sealing contact with the inner surface of re-usable liner 52 without being energized (i.e., without differential fluid pressure being required to hold primary and secondary cup seals 54 and 71 in place on re-usable liner 52). A pressurizing fluid may then be pumped into a fluid chamber 78 bounded by re-usable liner 52 and primary and secondary cup seals 54 and 71, through a suitable fluid inlet port 61 (which in the illustrated embodiment is in the form of a quick-connect fluid coupling in fixed seal body 53. To facilitate complete filling of fluid chamber 78 and elimination of air from fluid chamber 78, a bleed port 62 is preferably provided in association with fluid inlet port 61 (in fixed seal body 53 in the illustrated embodiment). When a pressurizing fluid is being introduced into fluid chamber 78, the liner assembly can be tilted such that fixed seal sub-assembly 75 is slightly higher than movable seal sub-assembly 68, with bleed port 62 being open to allow air to be purged from fluid chamber 78. When fluid chamber 78 has been filled with pressurizing fluid and air has been substantially purged therefrom, bleed port 62 is sealed by suitable means, such as a threaded plug 76.

As pressurizing fluid is introduced into fluid chamber 78, it will tend to migrate into anti-rotation outer tube 64 and anti-rotation inner tube 69, and also into extension shaft 65; such migration of the pressurizing fluid will typically be necessary (absent a fluid-tight fit between anti-rotation outer tube 64 and anti-rotation inner tube 69) to facilitate radial expansion of re-usable liner 52.

During adjustment of the length of the assembled fixed seal sub-assembly 75 and movable seal sub-assembly 68 (i.e., distance between primary and secondary cup seals 54 and 73), fluid chamber 78 will preferably be connected directly to a fluid reservoir (not shown), such as by way of one or more valves and fluid inlet port 61. The fluid reservoir would be open to the atmosphere, and preferably elevated so that when primary and secondary cup seals 54 and 73 are moved apart, a fluid head will be available to facilitate introduction of additional pressurizing fluid into fluid chamber 78 without allowing negative pressure to develop within fluid chamber 78 and draw air past the cup seals and into fluid chamber 78. Alternatively, the same utility can be provided by means of an auxiliary fluid pump (not shown). The rate of separation of primary and secondary cup seals 54 and 73 ideally should be slow enough that a vacuum is not formed, or, alternatively, the seal design can be designed to accommodate some negative pressure differential. When primary and secondary cup seals 54 and 73 are moved closer together, excess pressurizing fluid will flow (or be pumped) out of fluid chamber 78 and into the reservoir.

As may be seen in FIGS. 3 and 5, pressure equalization holes 67 may be provided through the wall of extension shaft 65 to allow displacement of fluid as nut-drive shaft 55 is turned. Additional fluid holes 77 may be provided through the wall of anti-rotation outer tube 64 allow fluid to pass as anti-rotation inner tube 69 moves in and out of anti-rotation outer tube 64.

Re-usable liner 52 must be radially and preferably elastically expandable when internally pressurized by a pressurizing fluid as described above. At the same time, it preferably will have a degree of inherent structural stiffness to facilitate insertion of the assembled fixed seal sub-assembly 75 and movable seal sub-assembly 68. Re-usable liner 52 preferably is made from high-density polyethylene (HDPE), which has been found to have the foregoing necessary or preferable characteristics. However, re-usable liner 52 may alternatively be made from other suitable materials, including thermoplastic materials other than HDPE, bearing in mind that the primary consideration in selecting a re-usable liner material is radial expandability.

The thickness of the wall of re-usable liner 52 would typically be selected with consideration to the required expandability and desired stiffness. As such, the selected wall thickness would generally be a function of the diameter of the pipe being slotted, and the specific properties of the selected liner material. However, it will be appreciated that the wall of re-usable liner 52 can be quite thin. Re-usable liner 52 acts largely like a bladder, since the axial forces induced by pressurization of fluid chamber 78 are structurally resisted by the assembled fixed seal sub-assembly 75 and movable seal sub-assembly 68. Accordingly, the primary structural requirement of re-usable liner 52 is the capacity to resist tensile hoop stresses resulting from pressurization, and it may be possible to meet this requirement with a comparatively thin re-usable liner, depending on the selected liner material.

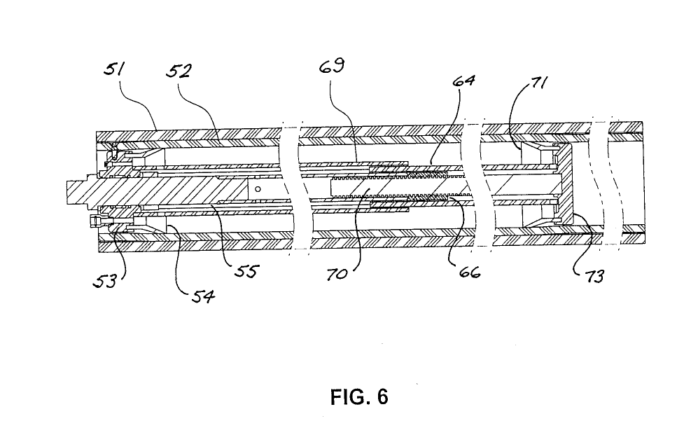

FIG. 6 illustrates liner seal assembly 50 with the assembled fixed seal sub-assembly 75 and movable seal sub-assembly 68 disposed within re-usable liner 52, which is in turn disposed and inflated within a sacrificial liner 51. Sacrificial liner 51 is preferably formed from HDPE or other suitable material as previously discussed with reference to re-usable liner 52. The outside diameter of re-usable liner 52 preferably will be only slightly less than the minimum internal diameter of sacrificial liner 51, to allow easy insertion of re-usable liner 52 into sacrificial liner 51, while minimizing the required extent to which re-usable liner 52 needs to be radially expanded in order to urge sacrificial liner 51 degree into contact with the inner wall surfaces of a pipe to be slotted in accordance with the method of the invention. For similar reasons, the outer diameter of sacrificial liner 51 preferably will be only slightly smaller than the nominal inside diameter of the pipe to be slotted (making allowance as appropriate for pipe out-of roundness and variations in pipe wall thickness).

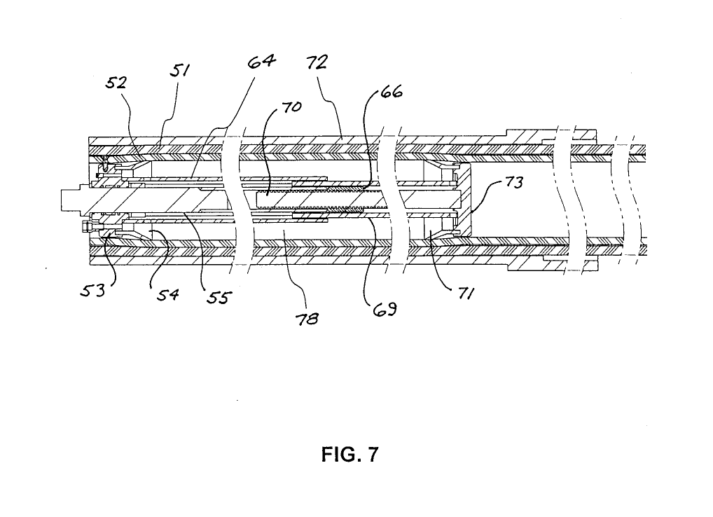

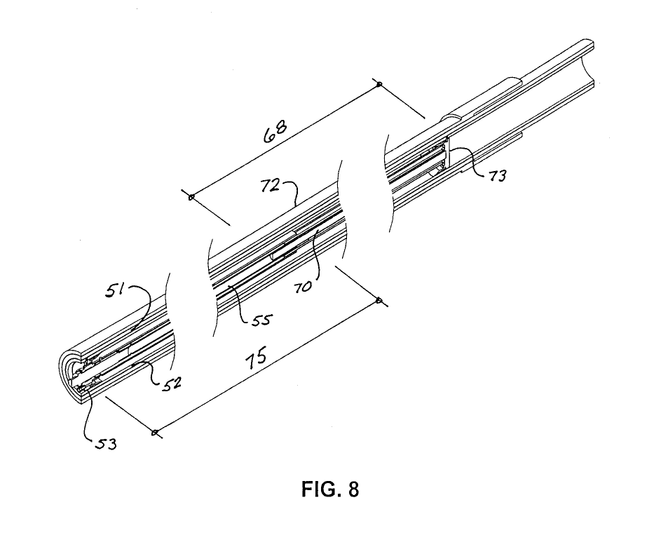

FIGS. 7 and 8 illustrate liner seal assembly 50, complete with re-usable liner 52 and sacrificial liner 51, inserted into a length of pipe 72 to be slotted in accordance with the method of the present invention. With the distance between primary and secondary cup seals 54 and 71 being set to suit the length of pipe 72, in accordance with the adjustment procedure previously described, a pressurizing fluid is pumped into fluid chamber 78 to radially expand re-usable liner 52, thereby urging sacrificial liner 51 into contact with the inner wall surfaces of pipe 72. The preferred pressurizing fluid is cutting fluid, because it will not contaminate the cutting fluid used by the slotting machine in the event of fluid leakage from liner seal assembly 50. However, various alternative pressurizing fluids (either liquid or gaseous) may be used to satisfactory effect, and without departing from the scope of the present method.

With liner seal assembly 50 thus installed and suitably pressurized, pipe 72 may now be slotted in accordance with the method of the present invention, using a conventional slotting machine fitted with one or more rotary slotting blades. Preferred embodiments of the method use slotting blades having novel geometries as previously described herein. However, persons of ordinary skill in the art will appreciate that the method of the invention can also be used to beneficial effect using other types of slotting blades.

In accordance with the method, the one or more rotating slotting blades are plunged radially through the wall of pipe 72, to a selected depth into sacrificial liner 51, which provides a barrier preventing metal cuttings from pipe 72 from breaking through to the bore of pipe 72. Sacrificial liner 51 thus prevents wickers from forming (or from remaining connected to the parent metal of pipe 72) by supporting the material excavated by the blades and allowing the blades to cut the excavated material into chips of sufficiently small size that they are readily removed from the cut slots by the teeth of the slotting blades. Upon completion of slotting operations, the outer surfaces of pipe 72 are flushed with cutting fluid to remove any cuttings or chips that may have adhered to the pipe surfaces. Concurrently or subsequently, fluid pressure within fluid chamber 68 is relieved as necessary so that re-usable liner 52 and sacrificial liner 51 retract radially away from the inner wall surfaces of pipe 72, thereby allowing liner assembly 50 to be fully withdrawn from pipe 72.

It will be readily appreciated that the wall of sacrificial liner 51 should be thick enough to prevent the slotting blades from penetrating completely through sacrificial liner 51 and into re-usable liner 52 (which could damage and possibly require replacement of re-usable liner 52). In a typical slotting application with pipe having a wall thickness of 0.375 inches and using a 3-inch diameter slotting blade with a one-inch diameter arbor, sacrificial liner 51 would theoretically require a minimum wall thickness of 0.625 inches to allow maximum penetration of the blade though the pipe wall without contacting re-usable liner 52. Accordingly, it can be seen that the required wall thickness for sacrificial liner 51 will depend on the blade and arbour diameters and/or the desired depth of blade penetration radially inward from the inner wall surface of the pipe. The determination of sacrificial liner wall thickness may also need to make allowance for variations in pipe wall thickness and pipe out-of-roundness. Reduced sacrificial liner thicknesses may be feasible in applications wherein depth of slotting blade penetration can be controllably limited to less than the full available depth (i.e., ½ (blade diameter minus arbour diameter)).

It will also be appreciated that it may be possible to use a particular sacrificial liner 51 with satisfactory effect for more than one slotting operation, even though the sacrificial liner may have multiple cuts from previous slotting operations. Once a sacrificial liner has reached the end of its practical useful life, it may be simply replaced with a new one.

### SUMMARY OF TEST RESULTS

The concepts embodied in this disclosure have been verified using laboratory testing. A test fixture was set up such that a single slotting blade could be plunged into a sample tubular while measuring the magnitude and nature of the loads at the blade/tubular interface. With this fixture, accurate comparisons could be made between different blades and different tubular materials.

### Modified Blade Tests

Tests were conducted on multiple material grades (K55 and L80 steel) using both a conventional slotting blade and a modified slotting blade having novel tooth geometry in accordance with the present invention. Tests conducted with the modified blade showed improvement in cutting performance both in the nature and the magnitude of the load with the modified blade. The improvement in cutting performance varied with differences in material properties and blade sharpness, but in most cases initial cutting loads were observed to be reduced by more than 50 percent when using the modified blades, as opposed to conventional slotting blades. Significant differences in the nature and consistency of cutting loads were also observed. Whereas conventional slotting blades often exhibit very inconsistent cutting load characteristics, with cutting loads regularly spiking well above the baseline cutting load, such load spiking was not observed when using the modified blades.

### Liner Material Tests

Tests were conducted on a variety of sacrificial and non-dulling materials to determine suitability for use as wicker-preventing sacrificial liner material. The results of these tests were qualitative in that the test results either yielded no wickers, which indicated success; or the test results showed that wickers still formed which indicated failure. The HDPE material was shown to be consistently effective in preventing wicker formation, while a variety of softer materials with lower melting points were shown to be less effective in preventing wicker formation.
Tests conducted with blades where all of the teeth were thinner than the main body of the blade demonstrated the best results (i.e., the lowest initial cutting loads and the most consistent cutting loads). Improved cutting performance was also demonstrated in tests with blades where less than all of the teeth were thinner than the main body of the blade. The improvement in cutting performance varied in accordance with the proportion of teeth that were thinner than the blade. A blade with less than all of the teeth thinner than the blade may be advantageous as the full-thickness teeth will act to increase the stability of the blade.

It will be readily appreciated by those skilled in the art that various modifications of the present invention may be devised without departing from the essential concept of the invention, and all such modifications are intended to come within the scope of the present invention and the claims appended hereto. It is to be especially understood that the invention is not intended to be limited to illustrated embodiments, and that the substitution of a variant of a claimed element or feature, without any substantial resultant change in the working of the invention, will not constitute a departure from the scope of the invention.

To provide only one non-limiting variant of the method of the invention, the beneficial effect of providing a liner assembly as described herein could also be achieved by completely or partially filling the pipe to be slotted with a molten and comparatively soft metal like solder for purposes of slotting operations, and subsequently melting the solidified metal out of the pipe. In a particularly preferred embodiment of this variant of the method, a layer of solder would be applied to the inside wall of the pipe using a centrifugal casting process. In either case (solder-filled pipe or internally solder-coated pipe), the solidified solder would act as a barrier to wicker formation in the same general fashion as the sacrificial liner of the liner assembly previously described herein. The same general principle could be embodied in a variant method wherein a mass or layer of thermoplastic material is deposited inside the pipe or on the inner wall of the pipe prior to slotting, and subsequently melted and recovered from the pipe.

In another variant, seal assembly 50 is of fixed length, to accommodate pipes in a specific narrow range of lengths, rather than being adjustable to accommodate a wider range of pipe lengths.

In this patent document, the word “comprising” is used in its non-limiting sense to mean that items following that word are included, but items not specifically mentioned are not excluded. A reference to an element by the indefinite article “a” does not exclude the possibility that more than one of the element is present, unless the context clearly requires that there be one and only one such element.

1. A blade comprising a circular main blade body having a first face and a second face, plus a plurality of cutting teeth arrayed around the circumference of the main blade body, wherein:
(a) at least two of the cutting teeth are thinned teeth, having a substantially uniform thickness less than the thickness of the main blade body;
(b) each thinned tooth has an inner face and an outer face, with each outer tooth face being flush with either the first or second face of the main blade body; and
(c) the face of the main blade body with which the outer faces of the thinned teeth are flush, alternates between said first and second faces from one thinned tooth to the next.

2. The blade of Claim I wherein the thickness of the thinned teeth is at least 50 percent of the thickness of the main blade body.

3. The blade of claim 1 wherein each tooth is of generally curvilinear configuration.

4. The blade of claim 1, further comprising, in association with each thinned tooth, a recessed area formed into the main blade body, with the surface of the recessed area being flush with the inner face of the corresponding thinned tooth.

5. The blade of claim 4 wherein each recessed area is of generally curvilinear configuration.

6. The blade of claim 1 wherein all of the cutting teeth are thinned teeth.

7. A method for slotting a round tubular workpiece, said method comprising the steps of:
(a) disposing a sacrificial liner adjacent the cylindrical inner surface of the tubular;
(b) plunging one or more rotating blades radially through the wall of the tubular and partially into the sacrificial liner; and
(c) removing the sacrificial liner from the tubular.

8. The method of claim 7 wherein the sacrificial liner is formed from a thermoplastic material.

9. The method of claim 8 wherein the thermoplastic material comprises high-density polyethylene.

10. The method of claim 7, comprising the further step of radially expanding the sacrificial liner to bring it into contact with the inner surface of the tubular.

11. The method of claim 10 wherein the step of radially expanding the sacrificial liner is carried out by the further steps of:
(a) inserting an expandable re-usable liner inside the sacrificial liner, said re-usable liner being sealed so as to define an internal fluid chamber; and
(b) introducing a pressurizing fluid into the re-usable liner's fluid chamber so as to radially expand the re-usable liner, such that the re-usable liner urges the sacrificial liner radially outward toward the inner surface of the tubular.

12. The method of claim 11 comprising the further step of providing an adjustable seal assembly whereby the length of the re-usable liner's fluid chamber can be adjusted to accommodate different lengths of pipe.

13. The method of claim 7 wherein the sacrificial liner comprises a mass of temporary filler material substantially filling the bore of the pipe, said filler material being appreciably softer than the parent metal of the pipe.

14. The method of claim 7 wherein the sacrificial liner comprises a layer of temporary filler material applied to the inner wall surfaces of the pipe, said filler material being appreciably softer than the parent metal of the pipe.

15. The method of claim 134 wherein the filler material comprises a thermoplastic material.

16. The method of claim 13 wherein the filler material comprises a metallic material.

17. The method of claim 16 wherein the metallic material is a solder.

18. The method of claim 13, comprising the further step of removing the filler material from the pipe bore by application of heat.

19. A method for cutting a slot through the wall of a ductile metal workpiece, said method comprising the step of plunging a rotating blade radially through the wall of the workpiece, wherein:
(a) the rotating blade is a blade comprising a circular main blade body having a first face and a second face, plus a plurality of cutting teeth arrayed around the circumference of the main blade body, wherein at least two of the cutting teeth are thinned teeth, having a substantially uniform thickness less than the thickness of the main blade body; each thinned tooth has an inner face and an outer face, with each outer tooth face being flush with either the first or second face of the main blade body; and the face of the main blade body with which the outer faces of the thinned teeth are flush, alternates between said first and second faces from one thinned tooth to the next;
(b) the depth of slot cut by the blade is at least ten time the thickness of the main blade body.

20. The method of claim 19 wherein the blade further comprises, in association with each thinned tooth, a recessed area formed into the main blade body, with the surface of the recessed area being flush with the inner face of the corresponding thinned tooth.

21. The method of claim 20 wherein each recessed area is of generally curvilinear configuration.

22. The method of claim 19 wherein all of the cutting teeth are thinned teeth.

23-26. (canceled)
